(19) United States
(12) Patent Application Publication
(10) Pub. No.: US 2009/0200815 A1
(43) Pub. Date: Aug. 13, 2009

(54) Pressure sensor and robot hand system

(75) Inventors: Atsushi Sugahara, Tokyo (JP); Hideki Ogawa, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/320,750

(22) Filed: Feb. 4, 2009

(30) Foreign Application Priority Data
Feb. 12, 2008 (JP) 2008-030655

(51) Int. Cl. G01L 9/00; B25J 15/08

(52) U.S. Cl. 294/106; 73/862.581; 901/31

(57) ABSTRACT

According to one embodiment in the invention, a pressure sensor includes: an inner flexible insulation substrate; a plurality of inner electrodes arranged on the inner flexible insulation substrate at a certain distance from each other; an outer flexible insulation substrate disposed along an outer face of the inner flexible insulating substrate so that the inner electrodes are disposed between the inner flexible insulation substrate and the outer flexible insulation substrate; a plurality of outer electrodes disposed on an outer face of the outer flexible insulation substrate at a given distance from each other; and an elastic cover covering the outer face of the outer flexible insulating substrate with the outer electrodes, wherein respective distances between the inner electrodes and the outer electrodes are variable by a pressure applied externally to the elastic cover.

### CROSS-REFERENCE TO RELATED APPLICATIONS

This application is based upon and claims the benefit of priority from Japanese Patent Application No. 2008-030655, filed Feb. 12, 2008, the entire contents of which are incorporated herein by reference.

### BACKGROUND

1. Field

The present invention relates to a pressure sensor and a robot hand system having the pressure sensor attached thereto.

2. Description of the Related Art

A conventional industrial robot hand rarely has a pressure sensor, and a pressure sensitive sheet capable of measuring a pressure on one point is stuck if any. A pressure distribution sensor having a plurality of touch spots is rarely used. The reason is as follows. If a size of an object to be handled is determined, it is possible to carry out a rough outline of work by opening and closing a hand in a size which is suitable for the object.

In an autonomous (intelligent) robot which will be important in the future, however, a capability to handle a plurality of objects skillfully according to the circumstances is required and a hand also needs a pressure sensor or a pressure distribution sensor which serves to measure a size or drag of the object.

JP-A-2006-305658, JP-A-2006-136983, JP-A-2004-333340, and JP-A-2004-333339 have disclosed examples that a pressure distribution sensor (or a tactile sensor) is attached to a robot hand.

In the pressure distribution sensor for the robot hand, it is necessary to take a durability of the sensor and an adhesion to the hand into consideration. The reason is that a load of several tens kg (several hundreds N) is applied to the robot hand in order to hold an object.

In the pressure distribution sensor, there is a sensor measuring a pressure change of capacitor and a resistance value between two electrodes. In some cases, the two electrodes are peeled away due to repetitive use. When a thick cover is put to enhance the durability, sensitivity is reduced. It is necessary to sufficiently examine a long-term reliability of an adhesive to be used everywhere. In a bonding portion of different types of objects, generally, a bonding force is reduced through a repetitive change in a temperature in the summer and winter for several years due to a difference in a coefficient of thermal expansion. It is necessary to take a countermeasure against them.

### SUMMARY OF THE INVENTION

According to an aspect of the present invention, there is provided a pressure sensor including: an inner flexible insulation substrate; a plurality of inner electrodes arranged on the inner flexible insulation substrate at a certain distance from each other; an outer flexible insulation substrate disposed along an outer face of the inner flexible insulating substrate so that the inner electrodes are disposed between the inner flexible insulation substrate and the outer flexible insulation substrate; a plurality of outer electrodes disposed on an outer face of the outer flexible insulation substrate at a given distance from each other; and an elastic cover covering the outer face of the outer flexible insulating substrate with the outer electrodes, wherein respective distances between the inner electrodes and the outer electrodes are variable by a pressure applied externally to the elastic cover.

According to another aspect of the present invention, there is provided a pressure sensor including a flexible insulation substrate including: a conductor wire; a first overlapping portion; a second overlapping portion overlapping with the first overlapping portion; a first through hole formed on the first overlapping portion; and a second through hole formed on the second overlapping portion; and an elastic column, wherein the flexible insulation substrate keeps a three-dimensional shape by bonding the first overlapping potion to the second overlapping portion so that the first through hole and the second through hole are communicated with each other to allow the elastic column to be inserted therethrough.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary developed perspective view showing a flexible insulating substrate constituting a pressure sensor and a robot hand to which the pressure sensor is attached according to a first embodiment of the invention,

FIG. 2 is an exemplary developed view showing the flexible insulating substrate constituting the pressure sensor in FIG. 1,

FIG. 3 is an exemplary perspective view showing a pressure sensor according to a second embodiment as seen from a back side,

FIG. 4 is an exemplary developed perspective view showing a state brought before assembling the pressure sensor of FIG. 3 as seen from the back side,

FIG. 5 is an exemplary typical view for explaining a principle of a pressure sensor according to a third embodiment of the invention,

FIG. 6 is an exemplary circuit block-diagram showing a structure of a capacitance detecting circuit of the pressure sensor in FIG. 5,

FIG. 7 is an exemplary typically longitudinal sectional view showing the pressure sensor in FIG. 5,

FIG. 8 is an exemplary perspective view showing the pressure sensor according to the third embodiment of the invention as seen from a back side,

FIG. 9 is an exemplary cross-sectional view showing a state in which a pressure sensor according to a fourth embodiment of the invention is attached to a robot hand,

FIG. 10 is an exemplary developed perspective view showing the pressure sensor of FIG. 9,

FIG. 11 is an exemplary developed view showing a substrate having an inner electrode which constitutes an inner electrode structure of the pressure sensor in FIG. 9, in which the electrode and a wiring are not shown,

FIG. 12 is an exemplary developed view showing a silicon rubber sheet constituting the inner electrode structure of the pressure sensor in FIG. 10,

FIG. 13 is an exemplary developed view showing a substrate having an inner electrode which constitutes the inner electrode structure in FIG. 11, in which the electrode and the wiring are shown,

FIG. 14 is an exemplary developed view showing a substrate having an outer electrode which constitutes an outer electrode structure of the pressure sensor in FIG. 10, in which the electrode and a wiring are not shown,

FIG. 15 is an exemplary developed view showing the substrate having an outer electrode in FIG. 14, in which the electrode and the wiring are shown,

FIG. 16 is an exemplary cross-sectional view showing a state in which a pressure sensor according to a fifth embodiment of the invention is attached to a robot hand,

FIG. 17 is an exemplary partially longitudinal sectional view showing the state in which the pressure sensor according to the fifth embodiment of the invention is attached to the robot hand,

FIG. 18 is an exemplary developed view showing a substrate having an inner electrode which constitutes an inner electrode structure of the pressure sensor according to the fifth embodiment of the invention, in which the electrode and a wiring are shown,

FIG. 19 is an exemplary longitudinal sectional view showing a pressure sensor according to a sixth embodiment of the invention,

FIG. 20 is an exemplary sectional plan view taken along an XX-XX line in FIG. 19, and

FIG. 21 is an exemplary sectional side view taken along an XXI-XXI line in FIG. 19.

### DETAILED DESCRIPTION

An embodiment of a pressure sensor according to the invention will be described below with reference to the drawings. Identical or similar portions to each other have common designations and repetitive description will be omitted.

### First Embodiment

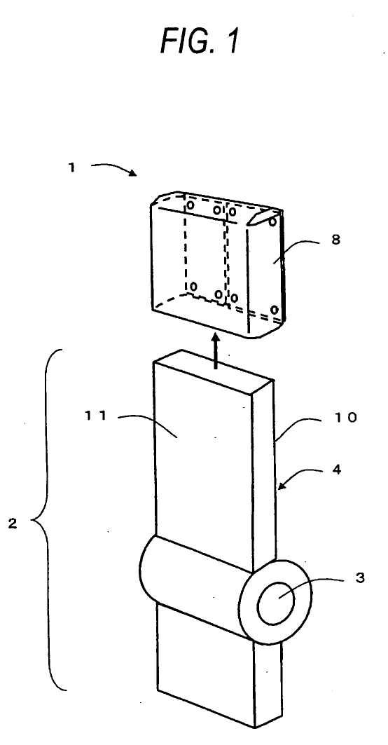

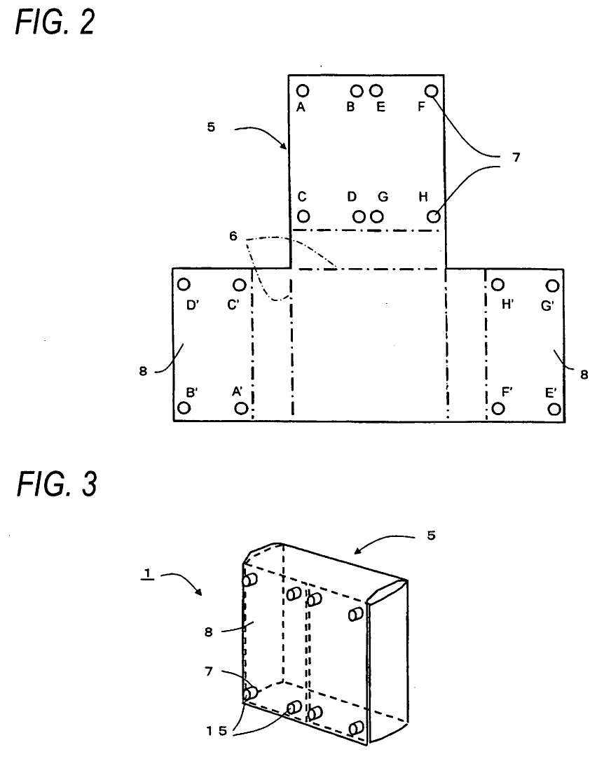

FIG. 1 is a developed perspective view showing a flexible insulating substrate constituting a pressure sensor and a robot hand to which the pressure sensor is attached according to a first embodiment of the invention, and FIG. 2 is a developed view showing the flexibility insulating substrate constituting the pressure sensor of FIG. 1.

A pressure sensor 1 according to the embodiment is fitted and attached, like a finger cot, into an end body portion 4 on a tip of an end body 3 of a finger 2 in the robot hand, for example. In the example shown in the drawing, the end body portion 4 takes a shape of a slender rectangular parallelepiped plate, and the pressure sensor 1 can be fitted like a cot from a tip thereof. The pressure sensor 1 is formed into a square cylinder by making a mountain fold at a right angle along a mountain fold line 6 of a sensor sheet 5 shown in FIG. 2. The sensor sheet 5 is of pressure sensitive rubber type, pressure sensitive ink type or capacity type, for example, and serves to detect an external pressure applied to each portion of the sheet in a direction of a thickness of the sheet together with position information thereof. The pressure sensor 1 subjected to bending takes such a shape that one of six faces of the rectangular parallelepiped is opened and can be put on a tip of the finger 2 of the robot hand through the opening.

A plurality of through holes 7 is formed on the sensor sheet 5. It is possible to rigidly fix mutual positions of the through holes 7 by inserting screws (not shown) in the through holes 7 to overlap the positions of the through holes 7 each other when the sensor sheet 5 is bent. More specifically, A and A′, B and B′, C and C′, D and D′, E and E′, F and F′, G and G′, H and H′ in the through holes 7 shown in FIG. 2 are overlapped respectively. Consequently, a shape shown in FIG. 1 is obtained. A screw hole is formed on the end body portion 4 of the robot finger 2 corresponding to the positions of the through holes 7 thus overlapped, and the screw inserted into the through hole 7 is put into the screw hole of the end body portion 4 so that the strength of the pressure sensor 1 can be ensured and the pressure sensor 1 can be firmly fixed to the end body portion 4.

In the embodiment, moreover, an overlapping portion 8 for the overlap of the sensor sheet 5 is positively ensured widely. Consequently, a rigidity of the sensor sheet 5 itself is enhanced so that the strength of the pressure sensor 1 is increased. By bonding the overlapping portions of the sensor sheet 5 with an adhesive, furthermore, it is possible to increase the strength of the pressure sensor 1.

By setting the overlapping portion 8 as a back side 10 of the finger 2 of the robot hand and preventing a front side 11 of the finger 2 from being the overlapping portion 8, it is possible to maintain a pressure detecting sensitivity of the front side 11 of the finger 2 to be a little high.

### Second Embodiment

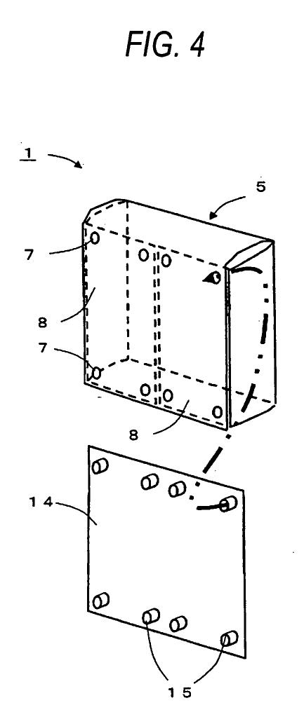

FIGS. 3 and 4 show a pressure sensor 1 according to a second embodiment of the invention, and FIG. 3 is a perspective view showing the pressure sensor 1 seen from a back side and FIG. 4 is a developed perspective view showing a state brought before an assembly of the pressure sensor 1 in FIG. 3 as seen from the back side. The second embodiment is a variant of a part of the first embodiment, and a plurality of projections 15 attached to one face of a rectangular plate 14 is used in place of the screw to be inserted into the through hole 7 of the sensor sheet 5. The plate 14 is configured to be disposed on an inside of an overlapping portion 8 of the sensor sheet 5 in such a manner that the projection 15 is turned outward. The projection 15 is disposed in a corresponding position to the through hole 7, and the through holes 7 are overlapped and the projection 15 is inserted therein. Consequently, the overlapping portions 8 of the sensor sheet 5 are fixed to each other in an overlapping state. Consequently, a shape of the pressure sensor 1 is held strongly.

### Third Embodiment

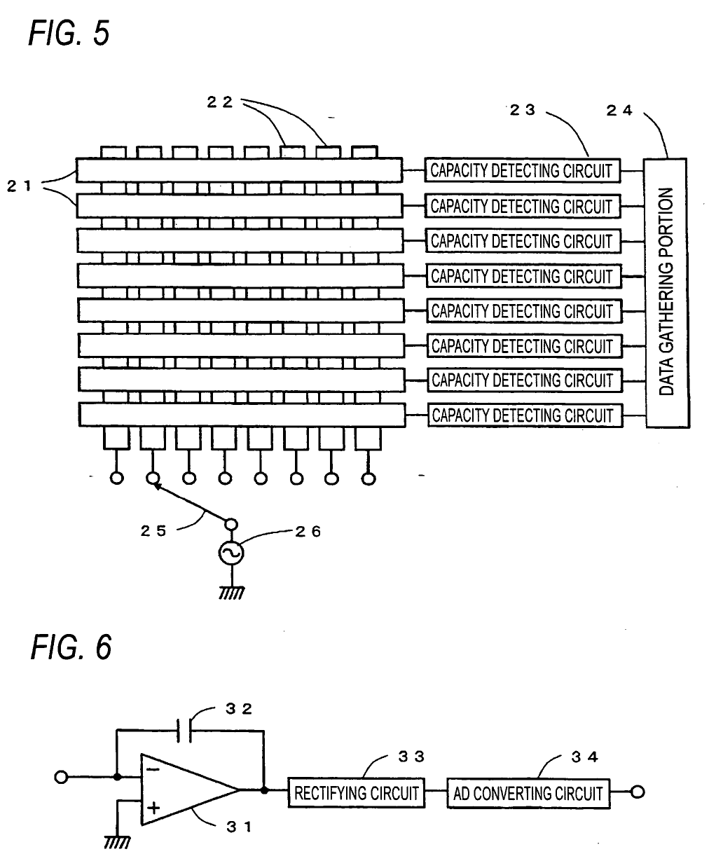

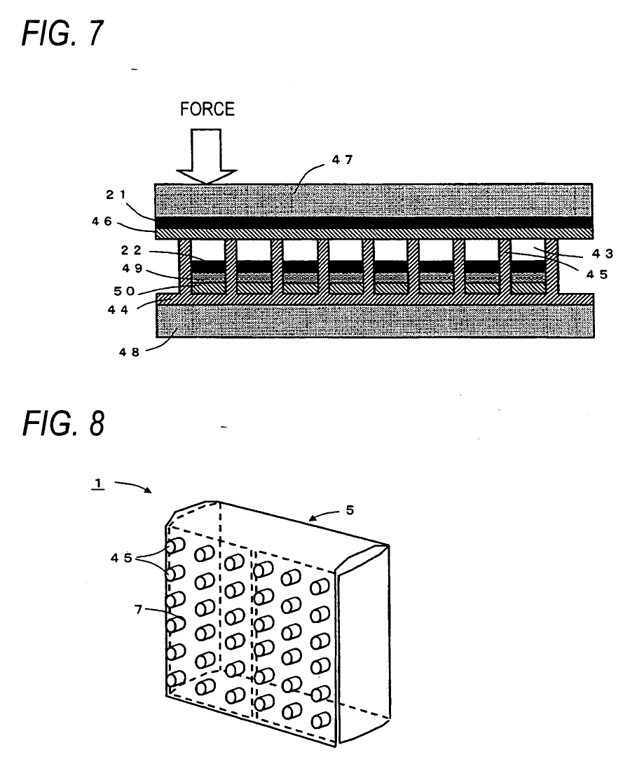

Next, a pressure sensor according to a third embodiment of the invention will be described with reference to FIGS. 5 to 8. The embodiment is obtained by materializing the structure according to the second embodiment as a capacitive pressure distribution sensor. FIG. 5 is a typical view for explaining a principle of a capacitive pressure sensor according to the third embodiment of the invention, and FIG. 6 is a circuit block diagram showing a structure of a capacitance detecting circuit of the pressure sensor in FIG. 5. FIG. 7 is a typically longitudinal sectional view showing the pressure sensor of FIG. 5. FIG. 8 is a perspective view showing the pressure sensor according to the third embodiment of the invention as seen from a back side.

First of all, the principle of the capacitive pressure sensor will be described with reference to FIG. 5. A plurality of strip-shaped detecting electrodes 21 is arranged in parallel with each other over one plane, and a plurality of strip-shaped signal electrodes 22 is arranged in parallel over another plane which is parallel with the surface where the detecting electrodes 21 are arranged. When the detecting electrode 21 and the signal electrode 22 are projected onto the surfaces as shown in FIG. 5, they are orthogonal to each other. In each position in which the detecting electrode 21 and the signal electrode 22 cross each other in FIG. 5, the detecting electrode 21 and the signal electrode 22 are opposed to each other with a clearance interposed therebetween to form a capacitor. The capacitive pressure distribution sensor serves to read a change in capacity of the cross portion of the detecting electrode 21 and the signal electrode 22.

A sine wave of approximately 100 kHz which is generated from a signal source 26 is applied to the signal-electrode 22 through a switch 25. The sine wave passes through capacitor C formed in the cross portion and is transmitted to the detecting electrode 21, and enters a capacitance detecting circuit 23. A plurality of capacitance detecting circuits 23 is arranged in parallel with each other and constitutes so-called CV converting circuits for switching a change in capacitance of the capacitor C into a change in a voltage.

As shown in FIG. 6, the capacitance detecting circuit 23 serves as the CV converting circuit which is an integrating circuit including an operational amplifier 31 and a feedback capacitor 32. A signal voltage of the sine wave is changed into a direct current through a rectifying circuit 33 and serves as a digital signal through an AD converting circuit 34. As shown in FIG. 5, the digital signal is collected in a data gathering portion 24 such as a personal computer and displays a pressure distribution—or is used in a trigger signal of a control for a robot hand.

In FIG. 7, the detecting electrodes 21 are extended in the transverse direction of the drawing and are arranged in a depth direction of the drawing and the signal electrodes 22 are extended in the depth direction of the drawing and are arranged in the transverse direction. An air gap 43 which is present in the crossing portion of the detecting electrode 21 and the signal electrode 22 forms capacitor. A silicon rubber substrate 44 to be a flexible insulating substrate is provided under the signal electrode 22 and a silicon rubber column (a columnar object) 45 formed thereon supports the detecting electrode 21 to hold the air gap 43. A flexible substrate (a flexible insulating substrate) 49 is bonded through a bonding layer 50 to a surface of the silicon rubber substrate 44, and the signal electrode 22 is disposed on the flexible substrate 49. An insulating film 46 is provided on a surface of the detecting electrode 21 to prevent electrical short circuit of the detecting electrode 21 and the signal electrode 22. Moreover, the electrodes are covered with elastic covers 47 and 48. An external force is applied from an outside so that the air gap 43 is deformed. Consequently, the capacitance is changed.

The silicon rubber column 45 is inserted into the through hole 7 formed on the pressure sensor sheet 5 described in the first and second embodiments. FIG. 8 shows the state. The silicon rubber column 45 is provided and inserted into the through hole 7 formed on the sensor sheet 5. The sensor sheet 5 shown in FIG. 8 corresponds to the flexible substrate 49 on which the signal electrodes 22 shown in FIG. 7 are formed. The column 45 is covered with a flexible substrate having the detecting electrode 21 formed thereon so that the capacitive pressure distribution sensor is obtained, which is not shown in FIG. 8. By the structure, it is possible to cause a finger cot type sensor to be strong by effectively using a column required originally in the capacitive pressure distribution sensor. The column forms the air gap 43 and fixes the overlapping portions each other without the adhesive.

### Fourth Embodiment

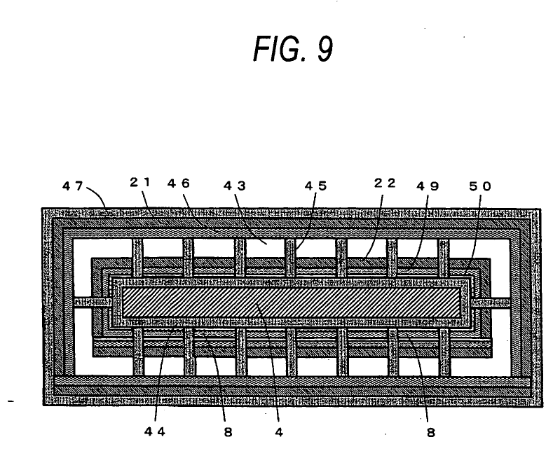

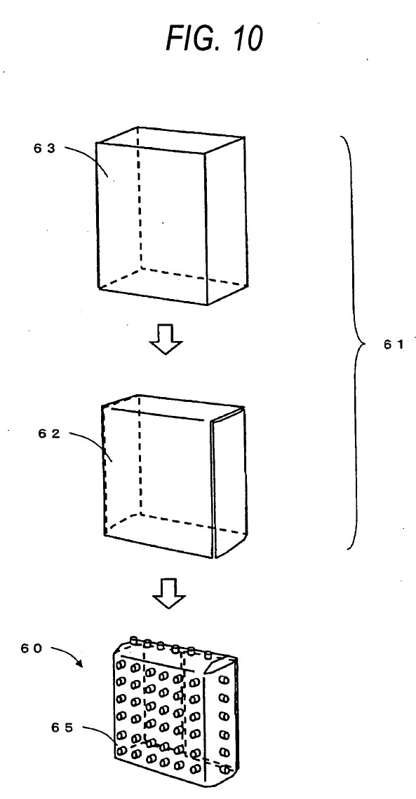

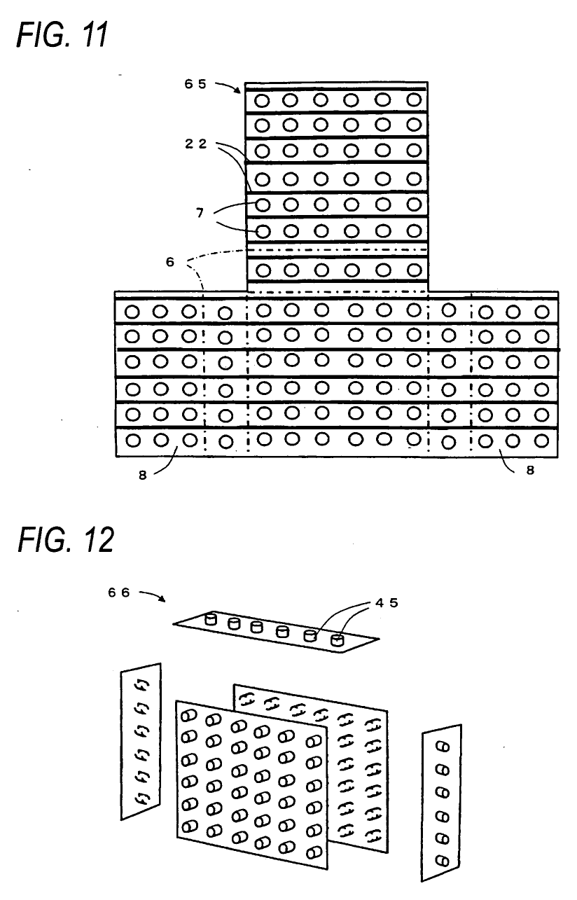

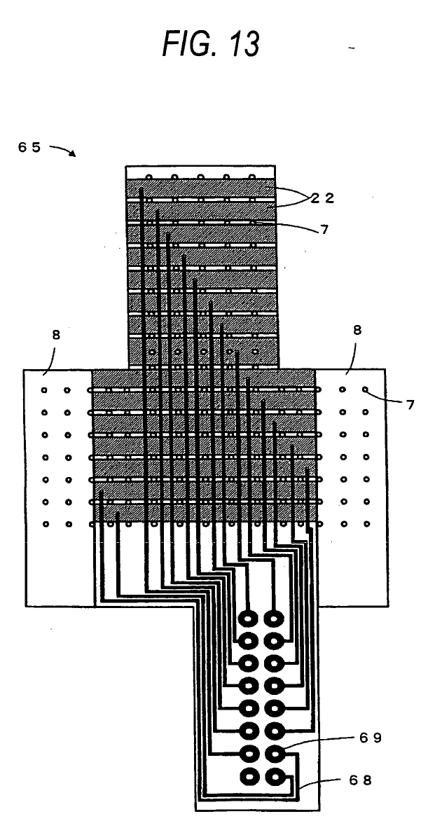

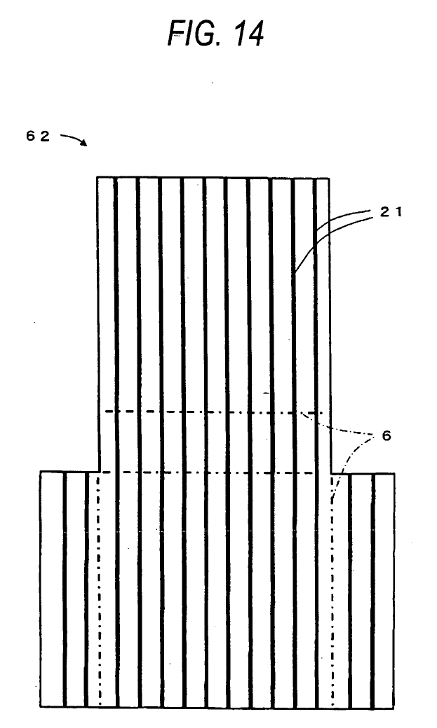

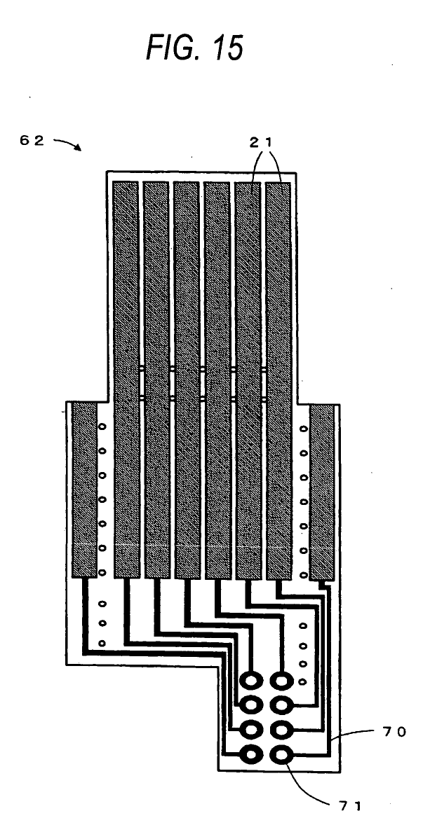

Next, a fourth embodiment of the pressure sensor according to the invention will be described with reference to FIGS. 9 to 15. FIG. 9 is a cross-sectional view showing a state in which the pressure sensor according to the fourth embodiment is attached to a robot hand, and FIG. 10 is a developed perspective view showing the pressure sensor of FIG. 9. FIG. 11 is a developed view showing a substrate having an inner electrode which forms an inner electrode structure of the pressure sensor in FIG. 9, in which the electrode and a wiring are not shown. FIG. 12 is a developed view showing a silicon rubber sheet forming the inner electrode structure of the pressure sensor in FIG. 10. FIG. 13 is a developed view showing the substrate having an inner electrode which forms the inner electrode structure of FIG. 11, in which the electrode and the wiring are shown. FIG. 14 is a developed view showing a substrate having an outer electrode which forms an outer electrode structure of the pressure sensor in FIG. 10, in which the electrode and a wiring are not shown. FIG. 15 is a developed view showing the substrate having an outer electrode in FIG. 14, in which the electrode and the wiring are shown.

The embodiment is a variant of the third embodiment and a pressure sensor 1 is formed by an inner electrode structure 60 and an outer electrode structure 61 covering an outside thereof as shown in FIG. 10. The outer electrode structure 61 is constituted by putting a cover (an elastic bag-shaped body) 63 having one of ends closed and taking a shape of a square cylinder on a substrate having an outer electrode (an outer flexible insulating substrate) 62 to be a flexible printed board which is bent. The pressure sensor 1 is put on an end body portion 4 of a finger of the robot hand and is thus used as shown in FIG. 9. In the embodiment, it is possible to detect a pressure over a whole periphery and in a tip portion of the end body portion 4 of the finger. The cover 63 is formed of a silicon rubber which has a thickness of 0.5 mm, for example.

The inner electrode structure 60 is constituted by combining a substrate having an inner electrode (an inner flexible insulating substrate) 65 to be a flexible printed board shown in FIG. 11 and a plurality of flexible silicon rubber sheets 66 shown in FIG. 12.

The substrate 65 having an inner electrode is the same as the sensor sheet 5 according to the first embodiment (FIG. 2), and a mountain fold is made along a plurality of mountain fold lines 6 so that a shape of a square cylinder having one of ends closed is obtained. A large number of signal electrodes (inner electrodes) 22 are disposed on the substrate 65 having an inner electrode. The signal electrodes 22 are provided in parallel with each other at an almost equal interval in a perpendicular direction to a direction in which a finger 2 of the robot hand is extended. A large number of through holes 7 are formed on the substrate 65 having an inner electrode. Moreover, an overlapping portion 8 is formed in the same manner as in the sensor sheet 5 according to the first embodiment (FIG. 2).

In order to hold the substrate 65 having an inner electrode in a bending state, the rectangular silicon rubber sheet 66 is inserted along an inside of each surface of the substrate 65 having an inner electrode which is bent. A large number of silicon rubber columns 45 are formed on each outer surface of the silicon rubber sheet 66 and are inserted into the through holes 7 of the substrate 65 having an inner electrode one by one so that the substrate 65 having an inner electrode in the bending state is formed into a square cylinder having one of ends closed, and is thus stabilized.

The substrate 65 having an inner electrode, the substrate 62 having an outer electrode and the silicon rubber sheet 66 according to the fourth embodiment correspond to the flexible substrate 49, the insulating film 46 and the silicon rubber substrate 44 according to the third embodiment, respectively.

As shown in FIG. 13, each of the signal electrodes 22 provided on the substrate 65 having an inner electrode is electrically connected to a land 69 through a lead wire 68 disposed on a back side of the substrate 65 having an inner electrode. By attaching a connector terminal to the land 69, it is possible to connect the signal electrode 22 to a signal source 26 (not shown).

As shown in FIGS. 14 and 15, the substrate 62 having an outer electrode takes a similar shape to that of the substrate 65 having an inner electrode and a size thereof is slightly larger than that of the substrate 65 having an inner electrode. By making a mountain fold along the mountain fold line 6 of the substrate 62 having an outer electrode, the substrate 62 having an outer electrode is formed into a square cylinder. In the embodiment, neither an overlapping portion, a through hole nor a columnar object is provided on the substrate 62 having an outer electrode. A large number of detecting electrodes (outer electrodes) 21 are disposed in parallel with each other at an almost equal interval on the surface of the substrate 62 having an outer electrode in the direction in which the finger 2 of the robot hand is extended. Each of the detecting electrodes 21 is electrically connected to a land 71 through a lead wire 70 disposed on the surface of the substrate 62 having an outer electrode.

### Fifth Embodiment

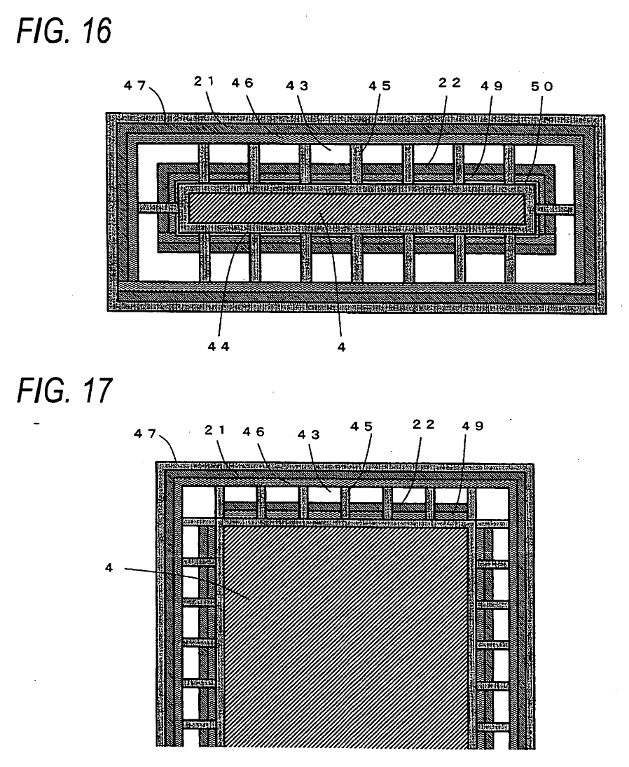

While the overlapping portion 8 is provided on the substrate 65 having an inner electrode in the fourth embodiment, the overlapping portion 8 is not provided on the substrate 65 having an inner electrode in a fifth embodiment shown in FIGS. 16 to 18.

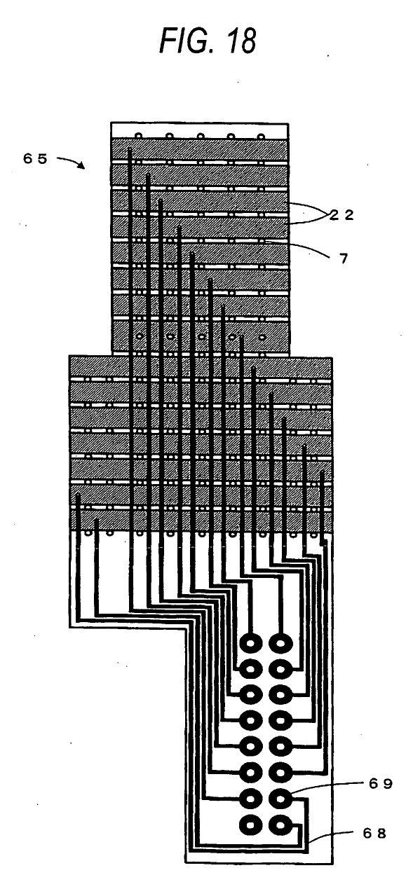

FIG. 16 is a cross-sectional view showing a state in which a pressure sensor according to the fifth embodiment is attached to a robot hand. FIG. 17 is a partially longitudinal sectional view showing a state in which the pressure sensor according to the fifth embodiment is attached to the robot hand. FIG. 18 is a developed view showing a substrate having an inner electrode which forms an inner electrode structure of the pressure sensor according to the fifth embodiment, in which the electrode and a wiring are shown.

In the pressure sensor according to the embodiment, the overlapping portion is not provided. Therefore, there is an advantage that the whole pressure sensor is more compact as compared with the fifth embodiment.

### Sixth Embodiment

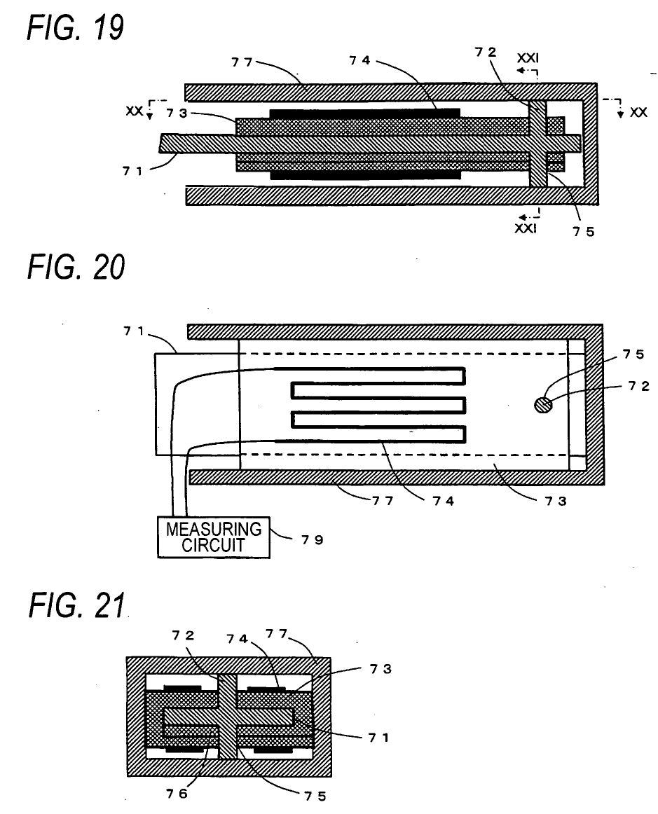

A sixth embodiment according to the invention will be described with reference to FIGS. 19 to 21. FIG. 19 is a longitudinal sectional view showing a pressure sensor according to the sixth embodiment, FIG. 20 is a sectional plan view taken along an XX-XX line in FIG. 19, and FIG. 21 is a sectional side view taken along an XXI-XXI line in FIG. 19.

A columnar object (projection) 72 is vertically protruded from both sides in the vicinity of one of ends of a rectangular elastic plate 71. A flexible substrate (a flexible printed board) 73 is wound to cover a part in a longitudinal direction of the elastic plate 71, and an electric resistor 74 is attached to both surfaces on an outside of the flexible substrate 73. More specifically, the flexible substrate 73 and the electric resistor 74 form a strain gauge, and the electric resistor 74 is connected to a measuring circuit 79 as shown in FIG. 20. A through hole 75 is formed on the flexible substrate 73 and the columnar object 72 penetrates them. An overlapping portion 76 is provided on the flexible substrate 73 and the through hole 75 is also formed in this portion. Therefore, the columnar object 72 penetrates the through holes 75. The flexible substrates 73 are bonded to each other through the overlapping portion 76. Therefore, a strong adhesion can be obtained because the same types of objects are bonded to each other.

A cover 77 for covering the whole object is provided and pushes the columnar object 72 therein. Consequently, the elastic plate 71 serves as a cantilever having a one-point load. Therefore, it is possible to measure a load applied to the sensor by the strain gauge formed by the flexible substrate 73 and the electric resistor 74. Differently from the first embodiment, a pressure is not measured by only a sheet-like sensor but the elastic plate 71 to be a framework is used as the cantilever.

### Other Embodiment

Each of the embodiments is only illustrative and the invention is not restricted thereto.

For example, although the signal electrode 22 is disposed on the substrate 65 having an inner electrode and the detecting electrode 21 is disposed on the substrate 62 having an outer electrode in the fourth and fifth embodiments (FIGS. 9 to 18), the detecting electrode 21 may be disposed on the substrate 65 having an inner electrode and the signal electrode 22 may be disposed on the substrate 62 having an outer electrode. While the signal electrode 22 is disposed in the perpendicular direction to the direction in which the finger 2 of the robot hand is extended and the detecting electrode 21 is disposed in the direction in which the finger 2 of the robot hand is extended in the fourth or fifth embodiment, moreover, the signal electrode 22 may be disposed in the direction in which the finger 2 of the robot hand is extended and the detecting electrode 21 may be disposed in the perpendicular direction to the direction in which the finger 2 of the robot hand is extended.

While the overlapping portion is not provided on the substrate 62 having an outer electrode in the fourth or fifth embodiment, furthermore, the overlapping portion may be provided on the substrate 62 having an outer electrode.

As described with reference to the embodiment, the embodiment enables a detection of a pressure in a plurality of portions over a surface of a robot hand with a high sensitivity in a stronger structure.

According to the embodiment, it is possible to detect a pressure in a plurality of portions over a surface of a robot hand with a high sensitivity in a stronger structure.

What is claimed is:

1. A pressure sensor comprising:
an inner flexible insulation substrate;
a plurality of inner electrodes arranged on the inner flexible insulation substrate at a certain distance from each other;
an outer flexible insulation substrate disposed along an outer face of the inner flexible insulating substrate so that the inner electrodes are disposed between the inner flexible insulation substrate and the outer flexible insulation substrate;
a plurality of outer electrodes disposed on an outer face of the outer flexible insulation substrate at a given distance from each other; and
an elastic cover covering the outer face of the outer flexible insulating substrate with the outer electrodes,
wherein respective distances between the inner electrodes and the outer electrodes are variable by a pressure applied externally to the elastic cover.

2. The pressure sensor according to claim 1 further comprising a plurality of elastic columns that are arranged between the inner electrodes and between the outer electrodes to keep the respective distances between the inner electrodes and the outer electrodes.

3. The pressure sensor according to claim 2, wherein at least one of the outer flexible insulation substrate and the inner flexible insulation substrate have a plurality of through holes configured to be filled by the elastic columns.

4. The pressure sensor according to claim 3, wherein at least one of the outer flexible insulation substrate and the inner flexible insulation substrate have overlapping portions that overlaps each other, at least a part of the through holes being formed on the overlapping portions and the overlapping portions being bonded to each other with an adhesive.

5. The pressure sensor according to claim 1, wherein the inner flexible insulation substrate, the outer flexible insulation substrate and the elastic cover are respectively configured to form a rectangular parallelepiped with an open bottom face.

6. The pressure sensor according to claim 1, wherein the inner electrodes include first longitudinal plates parallely arranged on a first virtual plane,
wherein the outer electrodes include second longitudinal plates parallely arranged on a second virtual plane that is parallel with the first virtual plane, and
wherein a longitudinal direction of the inner electrodes is orthogonal to a longitudinal direction of the outer electrodes.

7. A robot hand system comprising:
a robot hand;
an inner flexible insulation substrate disposed to cover an outer periphery of a tip portion of the robot hand;
a plurality of inner electrodes arranged on the inner flexible insulation substrate at a predetermined distance from each other;
an outer flexible insulation substrate disposed along an outer face of the inner flexible insulating substrate so that the inner electrodes are disposed between the inner flexible insulation substrate and the outer flexible insulation substrate;
a plurality of outer electrodes disposed on an outer face of the outer flexible insulation substrate at a given distance from each other; and
an elastic cover covering the outer face of the outer flexible insulating substrate with the outer electrodes,
wherein respective distances between the inner electrodes and the outer electrodes are variable by a pressure applied externally to the elastic cover.

8. A pressure sensor comprising:
a flexible insulation substrate including:
a conductor wire;
a first overlapping portion;
a second overlapping portion overlapping with the first overlapping portion;
a first through hole formed on the first overlapping portion; and
a second through hole formed on the second overlapping portion; and
an elastic column,
wherein the flexible insulation substrate keeps a three-dimensional shape by bonding the first overlapping potion to the second overlapping portion so that the first through hole and the second through hole are communicated with each other to allow the elastic column to be inserted therethrough.
